(19) United States
(12) Patent Application Publication
(10) Pub. No.: US 2010/0209672 A1
(43) Pub. Date: Aug. 19, 2010

(54) Metallic Layer Membrane

(76) Inventor: Yahya HODJAT, Oxford, MI (US)

Correspondence Address: THE GATES CORPORATION, IP LAW DEPT. 10-A3, 1551 WEWATTA STREET, DENVER, CO, 80202, US

(21) Appl. No.: 12/378,542

(22) Filed: Feb. 17, 2009

(51) Int. Cl. B32B 3/00; B32B 37/00

(52) U.S. Cl. 428/172; 156/163

(57) ABSTRACT

A membrane comprising a first elastomeric layer and a second elastomeric layer, a metallic layer deposited in a non-stressed condition on a substrate elastomeric layer when said substrate elastomeric layer is in a stretched condition, the metallic layer having zero gas permeability, the metallic layer and the substrate elastomeric layer disposed between and bonded to the first elastomeric layer and the second elastomeric layer, the first elastomeric layer and second elastomeric each comprising a cavity for receiving the metallic layer and substrate elastomeric layer upon a contraction of the membrane.

### FIELD OF THE INVENTION

The invention relates to a membrane having a metallic layer deposited on a substrate elastomeric layer in a non-stressed condition, the metallic layer having zero gas permeability.

### BACKGROUND OF THE INVENTION

Pressure accumulation tanks work under a very simple concept. The interior of a tank is divided into two sections, separated via a flexible membrane (bladder). On one side, usually the top side of the tank above the bladder, there is a high pressure gas, usually air. On the lower side, there is a liquid. The pressure from the gas behind the membrane results in a pressure on the liquid as it is being used (in an open loop system such as a water well) or as it is being recycled in a close loop system (such as a space heating water tank or a hydraulic system). In either case, the bladder keeps the pressure on the liquid, until the control system signal the pump(s) to pump more liquid into the tank.

The bladder is usually made of an elastomer, but it might also be a thermoplastic polymer. All of the materials used in such an application have a gas permeability greater than zero. That means the pressurized gas will gradually leak through the membrane into the liquid and the tank will gradually loose its ability to maintain a required pressure. This results in shorter and shorter time intervals between pump operations until it becomes just a full tank of water with little or no pressurization. In such a case the bladder just sticks to the walls of the tank.

Most tanks have an air valve for pumping more gas (or air) in the upper chamber. However, for many applications and users pumping air in the tank is inconvenient, difficult, or costly. For non-experts, over pressurizing the tank can be dangerous or fatal.

Permeability is a natural phenomenon with elastomers/polymers. Due to the material structure of elastomers/polymers various gases can permeate and go through them. For a given gas, usually the higher the gas pressure, the higher the permeability rate becomes.

On the other hand, metals have zero permeability for most gases. The only exception for metals is that hydrogen in its ionic form (essentially a proton) can permeate through metals. However hydrogen is never used in pressure accumulator tanks due to its explosiveness, its cost, and if the concern is its permeability through the bladder, it could permeate through the metal tank as well.

However, for air and other gases metals are a perfect material with zero permeability. Glass also has zero permeability. That is why carbonated soft drinks and/or beer keep their dissolved gases in an aluminum can or glass bottle after a long time, but, generally loose their gas pressurization in a plastic bottle over time.

Reducing permeability of polymers/elastomers by adding additive materials such as nano-clays, mica, or other additives to their mix formula is a known solution in the industry for applications where gas loses are not desired. However, these additives reduce the permeability, but, do not stop it completely. More importantly, these additives are usually added to polymers that are not made to stretch and shrink significantly. When significant stretching and shrinking occurs in an elastomer, since nano-clays, mica, and other similar gas blocking material do not stretch the space between them that is stretching could allow permeability and passage of gases.

Representative of the art is pending U.S. Pat. No. 5,042,176 (1991) which discloses a product in the form of a cushioning device made from thermoplastic film containing crystalline material inflated to a relatively high pressure and sealed at the time of manufacture. The product maintains the internal inflation pressure for long periods of time by employing a form of the diffusion pumping phenomenon of self-inflation in which the mobile gas is the gas components of air other than nitrogen. Improved and novel cushioning devices use new material, for the film of the enclosure envelope which can selectively control the rate of diffusion pumping, thereby permitting a wider latitude flexibility and greater accuracy in the design of such new cushioning device, thus improving the performance and reducing cost of such devices while eliminating some of the disadvantages of the earlier products. It is possible to permanently inflate certain types of new devices using readily available gases such as nitrogen, or air in which case nitrogen forms the captive gas.

What is needed is a membrane having a metallic layer deposited on a substrate elastomeric layer in a non-stressed condition, the metallic layer having zero gas permeability. The present invention meets this need.

### SUMMARY OF THE INVENTION

The primary aspect of the invention is a membrane having a metallic layer deposited on a substrate elastomeric layer in a non-stressed condition, the metallic layer having zero gas permeability.

Other aspects of the invention will be pointed out or made obvious by the following description of the invention and the accompanying drawings.

The invention comprises a membrane comprising a first elastomeric layer and a second elastomeric layer, a metallic layer deposited in a non-stressed condition on a substrate elastomeric layer when said substrate elastomeric layer is in a stretched condition, the metallic layer having zero gas permeability, the metallic layer and the substrate elastomeric layer disposed between and bonded to the first elastomeric layer and the second elastomeric layer, the first elastomeric layer and second elastomeric each comprising a cavity for receiving the metallic layer and substrate elastomeric layer upon a contraction of the membrane.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a side view of a membrane in the maximum metallic layer stretch condition.

FIG. 2 is a side view of a membrane in the metallic layer fully collapsed condition.

FIG. 3A is a top view of point contacts between an elastomer layer and the metallic layer.

FIG. 3B is a side view of point contacts between an elastomer layer and the metallic layer.

FIG. 4 is a top view of circular contacts between an elastomer layer and the metallic layer.

FIG. 5 is a top view of square contacts between an elastomer layer and the metallic layer.

FIG. 6 is a top view of circular line contacts between an elastomer layer and the metallic layer.

FIG. 7 is a top view of linear contacts between an elastomer layer and the metallic layer.

FIG. 8 is a schematic view of the manufacturing process.

FIG. 9 is a schematic view of the manufacturing process.

FIG. 10 is a schematic view of the manufacturing process.

FIG. 11 is a schematic view of the manufacturing process.

FIG. 12 is a cross-section detail of FIG. 1.

### DETAILED DESCRIPTION OF THE PREFERRED EMBODIMENT

In this invention, a very thin layer of aluminum or other suitable metal is used to reduce or eliminate gas permeability in an elastomer while keeping the elastomer flexible. To prevent the aluminum, for example, or other metallic additive from being stretched beyond its yield point and resulting in a plastic deformation or rupture of the metal layer, the forming of the membrane is accomplished while the bladder is stretched, for example, on a mandrel tooling to or above its maximum stretch point, namely, the highest elongation or stretch that will occur in the elastomer in application.

Once the bladder is relaxed, the thin layer of metal with its elastomeric polymer backing will wrinkle in a manner similar to taking an empty potato chip bag and crumpling it to a ball shape. In a like manner, after having crumpled, upon release the bag can expand without any problems. This can be repeated over many cycles.

The shape of the metal layer at bladder's zero stretch point (flat) is a wrinkled texture since the metal layer is applied in the fully expanded condition.

The few angstrom thick metal layer(s) can be created in many different ways, including: vapor depositing a thin layer of metal on an elastomer of existing art, and/or covering the metal side with an elastomer sheet to protect the metal. Further, depositing a thin layer of metal (a few angstroms) on a thin sheet of elastomer or thermoplastic or other suitable materials (textiles, etc.), or, using a second layer of polymer to sandwich the metal permanently in the middle.

Another method includes taking a very thin polymer/elastomer or other material and coating it on one or both sides and then sandwiching this material between two layers of elastomers or plastics.

Further, doing any of the preceding with multi layers of very thin metal and elastomers/polymers to assure very long durability for applications that need to be fail-proof, for example, in a very rare case that one metal layer fails others will be there.

When sandwiching one or more layers of metal coated material between non-coated and thicker material, it is ideal to mold the face of the sandwich material into shapes that allow collapsing of the thin metal layer easily and also to manage the shape of wrinkled metal layer in the non-expanded condition.

Some of the shapes for the relatively thick sandwich elastomer side that comes into contact with the thin metal layer include circular lines with thin line contact areas, or, dotted shape with small points on their tips, or, small circles with thin contact areas covering the entire surface. Other shapes include parallel lines with small contact points at the tip, or, any other shape or shapes that allow the metal layer to wrinkle, but, preferably in small sections to manage the wrinkling better and to prevent the metal from being pulled from its contact areas with the thicker outer layer elastomer.

A layer of thin metal is applied to a elastomer/polymer/textile substrate which is then sandwiched between two thicker elastomer/polymer materials. The thicker elastomer/polymer materials are sealed permanently to prevent any damage to the metal layer in transportation and assembly. It also makes the handling of bladders/membranes easy and convenient.

The inventive membrane is capable of expanding up to the limits of expansion of the elastomeric layers while maintaining zero gas permeability.

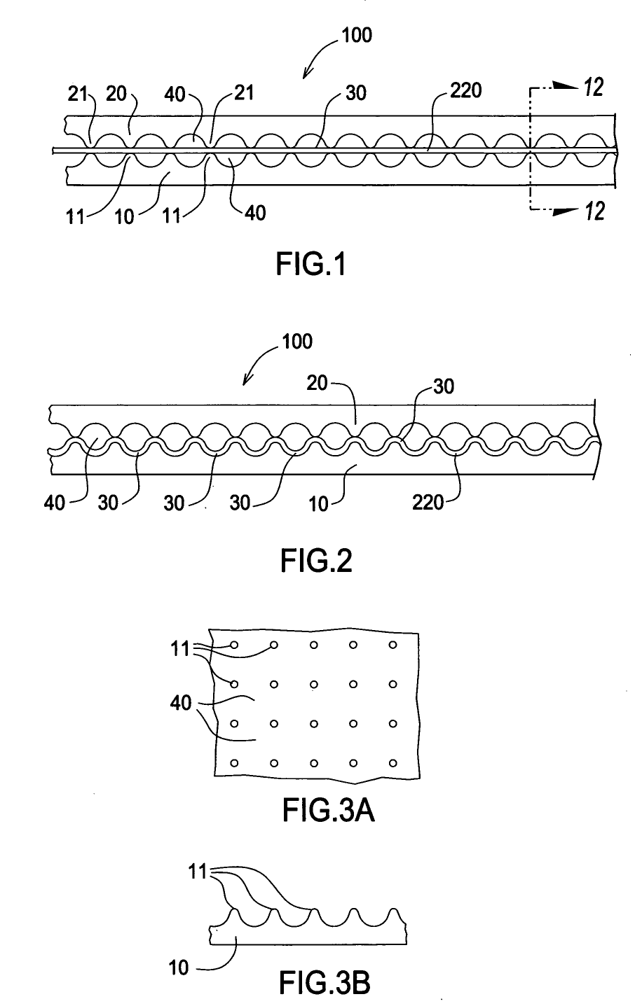

FIG. 1 is a side view of a membrane in the maximum metallic layer stretch condition. Membrane 100 comprises elastomeric layers 10 and 20 disposed on either side of the metallic layer 30. Metallic layer 30 further comprises an elastomeric substrate material 220 to which the metallic coating is applied. Layer 220 may comprise an elastomeric material or a plastic cloth or other suitable flexible material.

For example, elastomeric layers 10, 20 and 220 may each comprise butyl rubber, natural or synthetic rubbers, EPDM, VAMAC, NBR, silicon rubber, SBR, and polypropelene+EPDM, and any combination thereof. It is not necessary that the layers 10, 20, 220 comprise identical material.

The thickness of the metal applied to substrate 220 to form the metallic layer 30 is in the range of approximately 0+ to 50 angstroms (Å). FIG. 1 shows the metallic layer 30 with the membrane, and thereby layers 10, 20 and 220, in the fully stretched or expanded condition. Layer 30 is shown as substantially planar in this side view in order to more readily illustrate that the layer 30 has no wrinkles in the expanded condition. However, layer 30 is not stretched to yield and instead is in a substantially unstressed condition while at the same time the substrate layer 220 is fully stretched.

The metal used in metallic layer 30 may comprise aluminum, zinc, tin or lead or a combination of two or more of the foregoing metals.

Layer 10 contacts layer 220 and layer 20 contacts layer 30 at projections 11 and 21 respectively. In doing so, cavities 40 are defined adjacent to and on either side of the layers 30, 220.

As the membrane contracts, layer 30 and substrate layer 220 will take on a more wrinkled form which changes in shape and volume thereby partially occupying each cavity 40.

In an alternate embodiment, cavities 40 are only present in one of the layers 10 or 20. For example, cavities 40 are only present in layer 20, but cavities are not present in layer 10, hence layer 10 is flat at its contact with layer 220. In the alternative, layer 10 comprises cavities 40 and layer 20 is flat in its contact with layer 30.

FIG. 2 is a side view of a membrane in the metallic layer fully collapsed condition. In this figure layer 30, 220 are shown partially occupying each cavity 40. In effect, layer 30, 220 collapses into each cavity 40 as the elastomeric membrane is contracted from the fully stretched condition (FIG. 1) to the relaxed or contracted condition. Each cavity 40 is somewhat collapsed as well and yet accommodates the contracting metal layer 30 as well. For ease of illustration, each cavity 40 is shown having a circular cross section, however, in the collapsed condition it is expected that each cavity 40 will take a more oval appearance as projections 11, 21 move closer together.

FIG. 3A is a top view of contacts between an elastomer layer and the metallic layer. In this embodiment projections 11 and 21 engage layer 220 and layer 30 respectively in the pattern as shown.

At each location where layers 10 and 20 contact layer 220 and layer 30 respectively, a known adhesive is used, for example, Saret 633 (chemical name ZDA), Saret 634 (chemical name ZDMA) and Ricobond 1756 (chemical name PB-g-MA). In this manner the relative position of layer 30, 220 is controlled between layers 10 and 20 which prevents movement of layers 30, 220 with respect to projections 11, 21.

FIG. 3B is a side view of contacts between an elastomer layer and the metallic layer. Projections 11 cooperatively engage layer 220 with corresponding projections 21. Layer 30 is disposed therebetween.

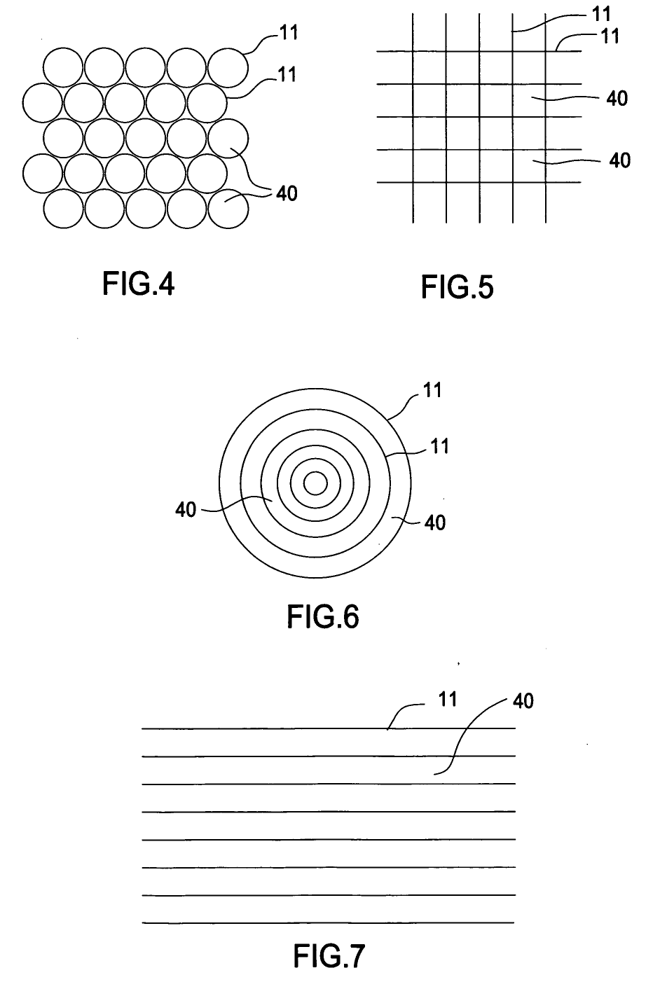

FIG. 4 is a top view of circular contacts between an elastomer layer and the metallic layer. In an alternate embodiment projections 11 and 21 form circular shapes at the contact with layer 220 and layer 30 respectively.

FIG. 5 is a top view of square contacts between an elastomer layer and the metallic layer. In an alternate embodiment projections 11 and 21 form cross-hatched lines at the contact with layer 220 and layer 30 respectively.

FIG. 6 is a top view of circular line contacts between an elastomer layer and the metallic layer. In an alternate embodiment projections 11 and 21 form concentric rings at the contact with layer 220 and layer 30 respectively.

FIG. 7 is a top view of linear contacts between an elastomer layer and the metallic layer. In an alternate embodiment projections 11 and 21 form parallel lines at the contact with layer 220 and layer 30 respectively.

One can see that each of the contact patterns described herein results in open spaces or cavities 40 between each layer 10, 20 and the layer 30, 220. In this manner, in the contracted condition layer 30 then has spaces in which to retract and expand.

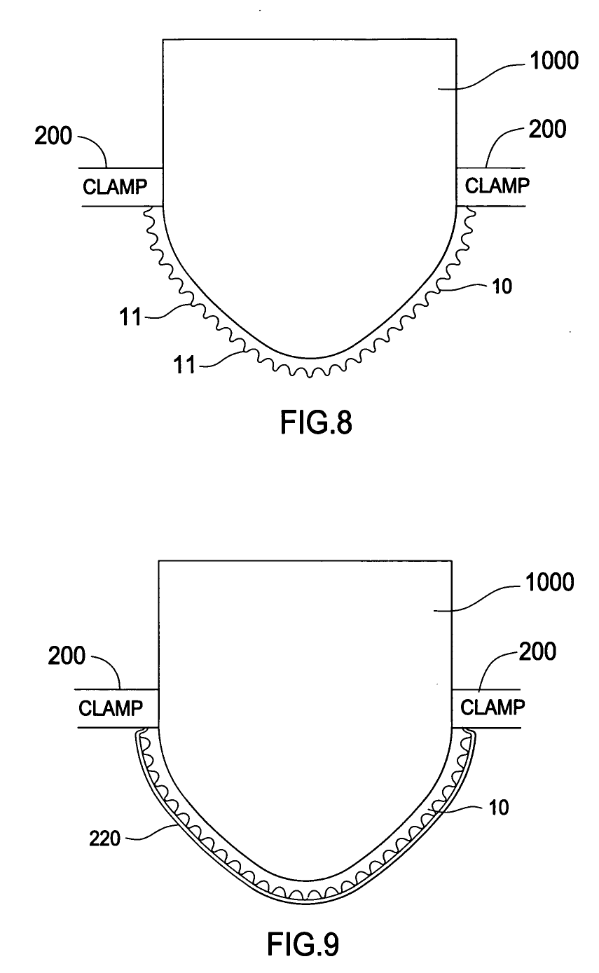

FIG. 8 is a schematic view of the manufacturing process. In the first step, a first elastomeric layer 10 is stretched over a mandrel 1000 and held in place by clamps 200. Mandrel 1000 holds layer 10 in a cup-like shape.

Layer 10 is held at maximum stretch for this step. Consequently, once applied, metallic layer 30 is never subjected to tensile loads or stress which could cause rupture.

FIG. 9 is a schematic view of the manufacturing process. In this second step a thin layer 220 of elastomer, in the range of approximately 0.01 mm to approximately 1 mm in thickness, is stretched and retained over the layer 10 by clamps 200. Layer 220 is fixed in place using adhesives at contact with each projection 11.

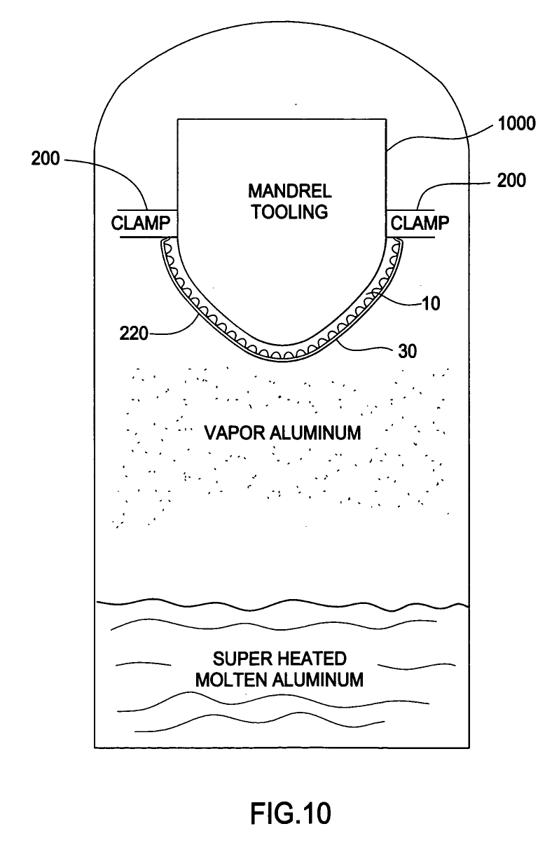

FIG. 10 is a schematic view of the manufacturing process. In the third step the metallic layer 30 is applied by quickly exposing the mandrel and layer 220 to vaporized metal. The vaporized metal is generated in a known manner using a process by which the metal is melted and superheated thereby forming a vapor for deposition.

Deposition of layer 30 in this manner results in layer 30 being in an unstressed condition having been applied to substrate 220, even though substrate 220 is at maximum stretch.

Application of layer 30 in this manner prevents layer 30 from failing or rupturing by applied tensile loads which would otherwise be imposed during pressurization and expansion of the membrane in a pressure accumulator.

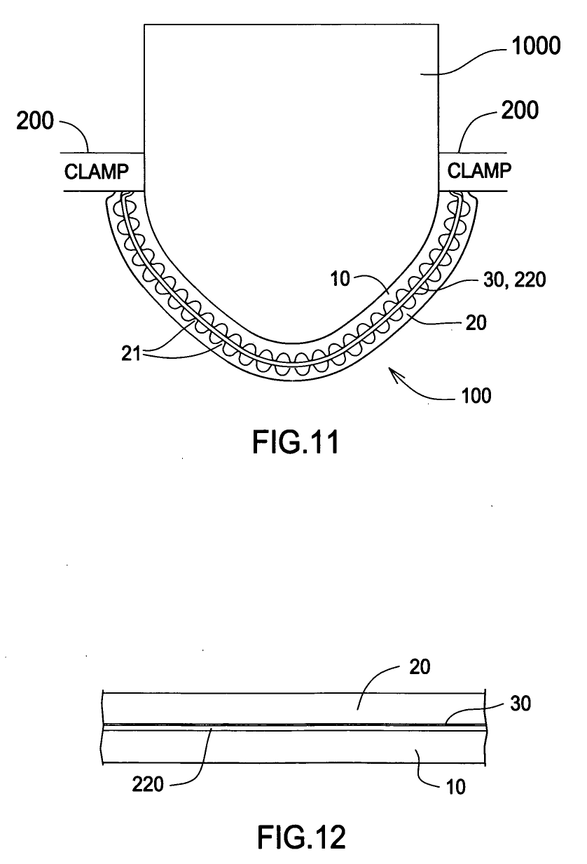

FIG. 11 is a schematic view of the manufacturing process. In the fourth step the elastomeric layer 20 is pulled over the layer 30 and fixed to layer 30 by using adhesives applied to projections 21. The completed membrane 100 is then removed from the mandrel.

As the membrane shrinks by removing it from the mandrel, and by pressure fluctuations during use, the metallic layer 30 will wrinkle (substrate 220 unstretched condition) and unwrinkled (substrate 220 stretched condition). Wrinkling of layer 30 is managed by the shape of the layers 10, 20 and cavities 40. Due to its thinness, layer 30 has great flexibility and may be wrinkled and unwrinkled through many cycles without failure. Layers 10, 20, further protect layer 30 and substrate 220 from impact damage. Layer 30 is therefore capable of operating in pressures normally associated with pressure accumulator service.

FIG. 12 is a cross-section detail of FIG. 1. Metal layer 30 is deposited by vapor deposition to substrate 220. The combined layer 30, 220 is bonded between layer 20 and layer 10.

Although a form of the invention has been described herein, it will be obvious to those skilled in the art that variations may be made in the construction and relation of parts without departing from the spirit and scope of the invention described herein.

I claim:

1. A membrane comprising:
a first elastomeric layer (10) and a second elastomeric layer (20);
a metallic layer (30) deposited in a non-stressed condition on a substrate elastomeric layer (220) when said substrate elastomeric layer is in a stretched condition, the metallic layer having zero gas permeability;
the metallic layer and the substrate elastomeric layer disposed between and bonded to the first elastomeric layer and the second elastomeric layer;
the first elastomeric layer and second elastomeric each comprising a cavity for receiving the metallic layer and substrate elastomeric layer upon a contraction of the membrane.

2. The membrane as in claim 1, wherein the second elastomeric payer comprises projections for contacting the metallic layer.

3. The membrane as in claim 1, wherein the first elastomeric layer comprises projections for contacting the substrate elastomeric layer.

4. A method of manufacturing a membrane comprising:
applying a first elastomeric layer in a stretched condition to a mandrel;
bonding a substrate elastomeric layer in a stretched condition to the first elastomeric layer;
applying a vaporized metal to the substrate elastomeric layer;
bonding a second elastomeric layer in a stretched condition to the substrate elastomeric layer; and
releasing the membrane from the mandrel.

5. The method as in claim 4 further comprising:
forming a cavity in the first elastomeric layer adjacent to the substrate elastomeric layer; and
forming a cavity in the second elastomeric layer adjacent to the substrate elastomeric layer.
